(19) United States
(12) Patent Application Publication
(10) Pub. No.: US 2010/0053444 A1
(43) Pub. Date: Mar. 4, 2010

(54) SIGNAL PROCESSING CIRCUIT AND SIGNAL PROCESSING METHOD FOR REMOVING CO-CHANNEL INTERFERENCE

(75) Inventor: Yue-Yong Chen, Zhu Hai City (CN)

Correspondence Address: J C PATENTS, 4 VENTURE, SUITE 250, IRVINE, CA, 92618, US

(73) Assignee: ALI CORPORATION, Taipei City (TW)

(21) Appl. No.: 12/277,589

(22) Filed: Nov. 25, 2008

(30) Foreign Application Priority Data
Aug. 27, 2008 (CN) 200810213343.0

(51) Int. Cl. H04N 5/00; H04N 9/64

(52) U.S. Cl. 348/607; 348/720; 348/E05.001; 348/E09.037

(57) ABSTRACT

A signal processing circuit and a signal processing method for removing a co-channel interference from a digital signal are provided. The signal processing circuit employs an adaptive filter for estimating a co-channel interference in a received digital signal. The adaptive filter takes the digital signal having a symbol signal outputted from a slicer subtracted therefrom as an input thereof. As such, the output of the adaptive filter does not contain any symbol data. Therefore, when the outputted estimation signal is subtracted from the received digital signal, it won't introduce any inter-symbol interference.

### CROSS-REFERENCE TO RELATED APPLICATION

This application claims the priority benefit of China application serial no. 200810213343.0, filed on Aug. 27, 2008. The entirety of the above-mentioned patent application is hereby incorporated by reference herein and made a part of specification.

### BACKGROUND OF THE INVENTION

1. Field of the Invention

The present invention generally relates to a digital signal processing circuit, and more particularly, to a circuit and a method for removing a co-channel interference from a digital signal.

2. Description of Related Art

The Federal Communications Commission (FCC) of the United States is planning to replace the color television broadcast standard set by the National Television System Committee (NTSC) of the United States with digital television. Other countries have such plan too. For receiving digital television signals, a user has to buy a TV set having a built-in digital television decoder, or a digital television set-top box (STB). However, it is not easy for all analog TV users to change digital TV sets or buy digital STBs in a short term. As such, a popular solution is to set up a certain period as a transitional period from analog signals to digital signals. During such a transitional period, analog signals and digital signals would be provided at the same time, or even in the same channel. In this case, the digital TV set or the STB must be able to overcome the problem of co-channel interference. Generally, comb filters or rejection filters are often employed for filtering to remove the co-channel interference. Unfortunately, although the co-channel interference can be removed in these ways, undesired inter-symbol interference may occur when filtering to remove the co-channel interference.

U.S. Pat. No. 5,132,797A1 issued in 1992 to Richard W. Citta proposes a technique for removing a co-channel interference. Citta '797 patent uses a comb filter for filtering to remove the co-channel interference, as shown in FIG. 1A. FIG. 1A is a block diagram of a co-channel interference filter disclosed in Citta '797 patent. A circuit of the co-channel interference filter includes two main sections, a comb filter 110 and an inter-symbol interference filter 150. The frequency responses of the comb filter 110 often include many notches, as shown in FIG. 1B, which sets forth a filter response curve for a portion of the co-channel interference filter of Citta '797 patent. As shown in FIG. 1B, the filter response curve includes a plurality of notches, three of which are used for filtering carrier of brightness, color, and voice. However, the rest notches cause unnecessary signal loss, while the comb filter 110 further introduces an inter-symbol interference (i.e., a signal 140 as shown in FIG. 1A contains a symbol data, and therefore when the signal 140 is added to a signal 120, an inter-symbol interference occurs). As such, Citta '797 patent employs a feedback filter (a delayer 160 and an amplifier 170) for eliminating the inter-symbol interference caused by the comb filter.

Further, in order to provide a solution of the problem caused by the unnecessary notches in the frequency response of the comb filter, U.S. Pat. No. 6,177,951B1 issued to Monisha Ghosh and assigned to Philip Electronics North America Corporation discloses a finite impulse response (FIR) filter, in which a frequency response of FIR filter is specifically designed for correspondingly removing all frequencies of the co-channel interference. Monisha Ghosh, the inventor of the '951 patent gave a group of coefficients of the FIR filter and their corresponding frequency responses in a related article depicting this technology, as shown in FIG. 2A.

FIG. 2A is a circuit diagram of an FIR filter disclosed by Monisha Ghosh. However, an input to the FIR filter 210 of FIG. 2A contains a symbol data, and therefore an output yₖ of the FIR filter 210 also contains a symbol data. In other words, an inter-symbol interference has been introduced therein. In Ghosh '951 patent, a feedback filter 220 is also employed for filtering to remove the inter-symbol interference introduced by the FIR filter 210. Since the frequency response of the FIR 210 is specifically designed for correspondingly filtering to remove the frequencies of the co-channel interference, the frequencies of the co-channel interference must be known. As such, if there is any deviation of the practical frequency of co-channel interference, the performance of Ghosh '951 patent will be impaired. Further, an application of the FIR filter 210, when there is no co-channel interference, may cause unnecessary signal loss.

FIG. 2B illustrates an NTSC frequency spectrum and a rejection filter spectrum of conventional technologies. As shown in FIG. 2B, all signals to a rejection filter will be attenuated in a response frequency band, and if there is no co-channel interference existed in such a frequency band, unnecessary signal loss will be caused.

U.S. Pat. No. 6,177,951B1 requires that the frequencies of the co-channel interference must be known, suffers the difficulty that an application of the FIR filter when there is no co-channel interference may cause unnecessary signal loss. In fact, another U.S. Pat. No. 5,777,692A1 issued to Monisha Ghosh assigned to Philips has provided a corresponding solution thereto, while the 692' patent is even invented earlier than the 951' patent for several months. FIG. 3 is a circuit diagram illustrating an integration of an adaptive filter and a decision feedback equalizer (DEF). Details of FIG. 3 can be learnt by referring to the specification of U.S. Pat. No. 5,777,692A1.

According to the Ghosh 692' patent, an adaptive filter 320 is used for tracking a frequency and an amplitude of the co-channel interference, and is thus used for automatically adapting a variation of the frequency of the co-channel interference and avoiding unnecessary signal loss when there is no co-channel interference. However, an input of the adaptive filter 320 contains a symbol data so that an output of the adaptive filter 320 also contains a symbol data, and therefore such an adaptive filter 320 still introduces an inter-symbol interference. When the inter-symbol interference is detected by the equalizer (constituted by a forward filter 330 and a feedback filter 340), the equalizer will try to eliminate the inter-symbol interference. However, when trying to eliminate the inter-symbol interference, the equalizer reintroduces the co-channel interference, and countervails the effect of the adaptive filter 320. For the purpose of preventing this situation, Ghosh 692' patent employs a delayer 310 to have the inter-symbol interference introduced by the adaptive filter 320 exceeding a detectable range of the equalizer.

However, although doing so successively avoids the counteraction between the equalizer and the adaptive filter 320, the inter-symbol interference introduced by the adaptive filter 320 is still there and is not removed. As such, the performance of the system is still unsatisfactory. Even further, upon the employment of such a delayer 310, when a subtraction is conducted between the output of the adaptive filter 320 and an output of the equalizer (i.e., the forward filter 330 and the feedback filter 340), because the adaptive filter 320 is delayed for a longer time, the co-channel interference of the output of the adaptive filter 320 and the output of the equalizer (330 and 340) may be to some degree different after a long time. Analog television signals scan from top to bottom, and therefore because of the delay of the adaptive filter 320, relative to the output of the equalizer (330 and 340), the output of the adaptive filter 320 corresponds to an upper position in an image frame, or even a certain position in a previous image frame. As such, the subtraction proposed by Ghosh '692 patent does not well remove the co-channel interference. These two aforementioned problems, introduced inter-symbol interference not being removed and delay causing different co-channel interference, might be the reason that initiates Philips to develop a non-adaptive filter disclosed in Ghosh '951 patent.

### SUMMARY OF THE INVENTION

Accordingly, the present invention is directed to provide a circuit and a method for removing a co-channel interference, in which a signal, from which a symbol data has been subtracted, is taken as an input of an adaptive filter for predicting a co-channel interference, thus removing the co-channel interference from a digital data and avoiding generation of additional inter-symbol interference.

The present invention further provides a signal processing circuit, suitable for removing a co-channel interference from a digital signal. The digital signal includes a plurality of symbols, a noise, and a co-channel interference. The signal processing circuit includes a first arithmetic unit, a slicer, a second arithmetic unit, and a filter. The first arithmetic unit is used for receiving the digital signal, and subtracting an estimation signal from the digital signal for outputting a first digital signal. The slicer is coupled with the first arithmetic unit, for quantizing the first digital signal for outputting a symbol signal corresponding to the symbols. The second arithmetic unit is coupled to an output of the slicer, and is used for subtracting the symbol signal from the digital signal for outputting an interference signal. The filter is coupled between the first arithmetic unit and the second arithmetic unit, for filtering the interference signal and outputting the estimation signal.

According to an embodiment of the present invention, the filter has a plurality of tap coefficients, and is used for dynamically adjusting the tap coefficients for adjusting the estimation signal corresponding to the co-channel interference.

According to an embodiment of the present invention, the filter is used for dynamically adjusting the tap coefficients according to a difference between the first digital signal and the symbol signal for adjusting the estimation signal corresponding to the co-channel interference.

According to an embodiment of the present invention, the signal processing circuit further includes a forward filter and a feedback filter. The forward filter is used for filtering a forestage signal, so as to output a first forestage signal. The feedback filter is coupled to the output of the slicer for filtering the symbol signal, so as to output an echo signal to a third arithmetic unit. The third arithmetic unit is coupled between the forward filter and the feedback filter, for subtracting the echo signal from the first forestage signal, thus outputting the digital signal.

According to an embodiment of the present invention, the signal processing circuit further includes a frequency domain equalizer, for equalizing a forestage signal to output the digital signal. The frequency domain equalizer includes a Fourier transformer, a frequency domain filter, and an inverse-Fourier transformer. The Fourier transformer is used for performing a Fourier transformation to the forestage signal. The frequency domain filer is coupled to an output of the Fourier transformer, and the inverse-Fourier transformer is coupled to an output of the frequency domain filter, and is used for transforming the output of the frequency domain filter to generate the digital signal in time domain.

According to an embodiment of the present invention, the filter is an adaptive filter.

According to an embodiment of the present invention, both of the first arithmetic unit and the second arithmetic unit are subtractors.

According to an embodiment of the present invention, the third arithmetic unit is a subtractor.

According to an embodiment of the present invention, when the feedback filter outputs an inversed signal of the echo signal, the third arithmetic unit adds the first forestage signal to the inversed signal of the echo signal for outputting the digital signal.

According to an embodiment of the present invention, the filter takes the first digital signal as an error signal, and is used for adjusting the tap coefficients with a least mean square (LMS) algorithm.

Viewing from another point, the present invention further provides a signal processing method, including the steps of: receiving a digital signal, the digital signal including a plurality of symbols, a noise, and a co-channel interference; subtracting an estimation signal from the digital signal for outputting a first digital signal; quantizing the first digital signal for outputting a symbol signal corresponding to the symbols; subtracting the symbol signal from the digital signal for outputting an interference signal; filtering the interference signal with an adaptive filter for outputting the estimation signal, and dynamically adjusting a plurality of tap coefficients of the adaptive filter according to the first digital signal for adjusting the estimation signal to correspond to the co-channel interference.

The present invention adopts a signal, from which a symbol data has been subtracted, as an input of an adaptive filter for estimating a co-channel interference in a digital data, and therefore is capable of removing the co-channel interference from the digital data without generating any additional inter-symbol interference, and does not requires the equalizer to specifically deal with an inter-symbol interference.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a block diagram of a co-channel interference filter disclosed by U.S. Pat. No. 5,132,797A1.

FIG. 1B is a diagram illustrating a frequency response of a comb filter disclosed by U.S. Pat. No. 5,132,797A1.

FIG. 2A is a circuit diagram of a finite impulse response (FIR) filter disclosed by Monisha Ghosh.

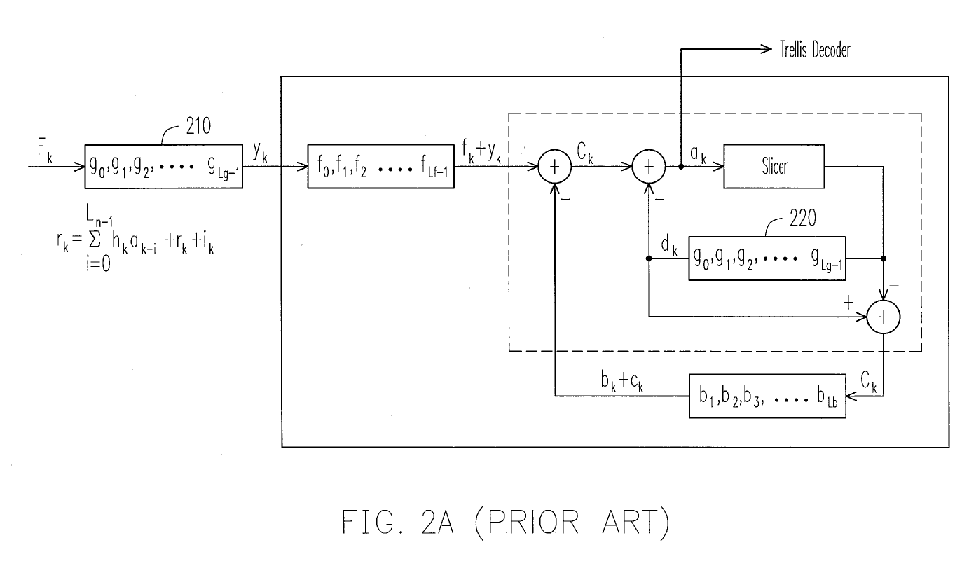

FIG. 2B illustrates an NTSC frequency spectrum and a rejection filter spectrum of conventional technologies.

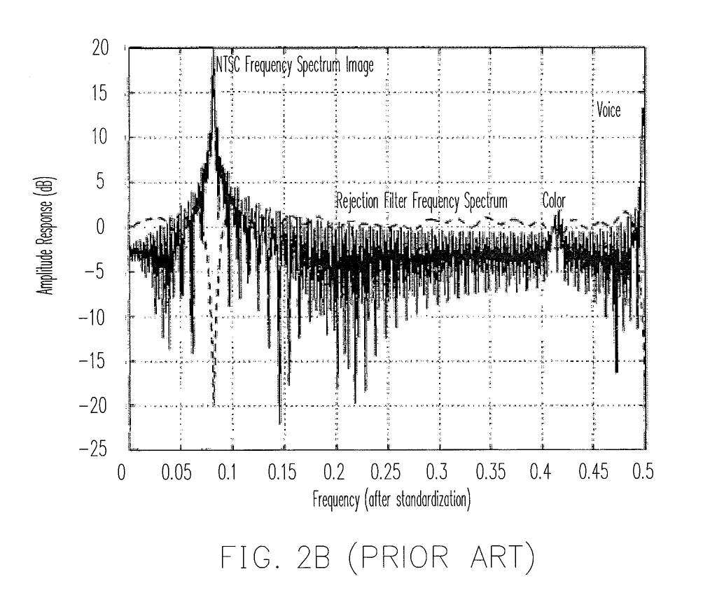

FIG. 3 is a circuit diagram illustrating an integration of an adaptive filter and a decision feedback equalizer (DEF) disclosed by U.S. Pat. No. 5,777,692A1.

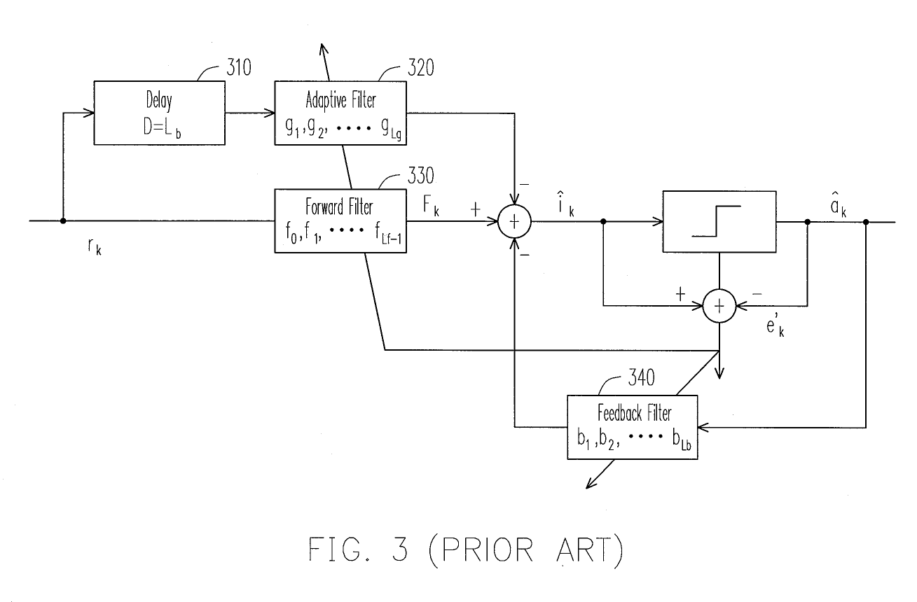

FIG. 4 is depicts a signal processing circuit according to a first embodiment of the present invention.

FIG. 5 is a circuit diagram illustrating an integration of a signal processing unit and an equalizer according to a second embodiment of the present invention.

FIG. 6 is a circuit diagram illustrating an integration of a signal processing unit and a frequency domain equalizer according to a third embodiment of the present invention.

FIG. 7 is a signal processing flow chart according to a fourth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

After being received by an antenna, a digital television signal will be converted to an intermediate frequency band signal by a tuner. Then, a co-channel interference and other noises, e.g., additive white Gaussian noise (AWGN), are then filtered from the signal. And finally, the signal is decoded and outputted to a display for displaying.

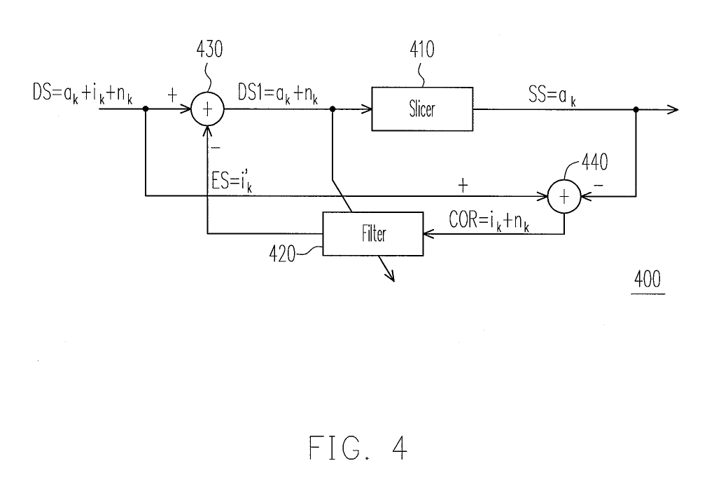

In the current embodiment, a signal processing circuit for removing a co-channel interference from a digital signal is to be illustrated. FIG. 4 is depicts a signal processing circuit according to a first embodiment of the present invention. Referring to FIG. 4, a signal processing circuit 400 includes a slicer 410, a filter 420, a first arithmetic unit 430, and a second arithmetic unit 440. The slicer 410 is coupled between the first arithmetic unit 430 and the second arithmetic unit 440. The filter 420 is also coupled between the first arithmetic unit 430 and the second arithmetic unit 440, and is further coupled to an input terminal of the slicer 410.

The first arithmetic unit 430 receives a digital signal DS, which can be represented as:

DS=aₖ+iₖ+nₖ,

in which aₖ represents the k^{th} symbol, iₖ represents a co-channel interference corresponding to the k^{th} symbol, nₖ represents a noise (e.g., AWGN)corresponding to the k^{th} symbol, and k is an index value of the symbols, such as integral numbers 1, 2, 3, . . . .

After receiving the digital signal DS, the first arithmetic unit 430 subtracts an estimation signal ES corresponding to the co-channel interference (e.g., an NTSC co-channel interference) from the digital signal DS, and outputs the result of the subtraction as a first digital signal DS1, which can be represented as:

DS1=DS−ES=aₖ+iₖ+nₖ−i′ₖ=aₖ+nₖ,

in which i′ₖ represents the estimation signal ES, which is an estimated value of the co-channel interference iₖ. When the filter 420 correctly estimates, the estimation signal i′ₖ is equal to a next time iₖ. Otherwise, when the filter 420 fails to correctly estimate, a part of the co-channel interference iₖ will reside in the digital signal DS1. In this case, the filter 420 adjusts the value of the estimation signal ES by adjusting tap coefficients of the filter 420 (e.g., represented as g₁, g₂, . . . , g_{1g}), so as to have the value of the estimation signal ES approaching to the next time iₖ.

The slicer 410 then quantizes the first digital signal DS1, and then outputs a symbol signal SS. After the quantization, the noises nₖ are removed from the first digital signal DS1, so that only the symbols aₖ are left in the symbol signal SS, i.e., a portion of the digital signal. In this case, the symbol signal SS is equivalent to the symbols aₖ of the digital signal DS. The second arithmetic unit 440 subtracts the symbol signal SS from the digital signal DS, and then outputs an interference signal COR (i.e., iₖ+nₖ) to an input terminal of the filter 420.

The filter 420 may estimate a co-channel interference of a next duty cycle by, for example, linear prediction, so as to output the estimation signal ES. The linear prediction is a mathematic method for estimating a prospective discrete signal according to a linear function calculation upon available sample points. The filter 420 of the present invention may employs a configuration of a finite impulse response (FIR) filter or an infinite impulse response (IIR) filter. In the current embodiment, the filter 420 is a FIR filter.

Taking the first digital signal DS1 as an error signal, the filter 420 is used for dynamically adjusting tap coefficients of the filter 420, and tuning a gain frequency band of the filter 420 to a frequency band of the co-channel interference. The filter 420 adopts, for example, a least mean square (LMS) algorithm. After filtering the interference signal COR, the filter 420 outputs the estimation signal ES. The estimation signal ES is the co-channel interference corresponding to the digital signal DS. The first arithmetic unit 430 subtracts the estimation signal ES from the received digital signal DS, for removing the co-channel interference from the digital signal DS.

In the current embodiment, the filter 420 has N tap coefficients, C₀, C₁, . . . , C_{N-1}, and N corresponding data, D₀, D₁, . . . , D_{N-1}. The tap coefficients and the corresponding data are provided for predicting a next time co-channel interference (e.g., iₖ₊₁) by a plurality of present known co-channel interference (e.g., iₖ, iₖ₋₁, i_{k-2 . . .} ). An equation for predicting the estimation signal ES is:

$$ES = {\sum }_{i = 0}^{N - 1} Ci * Di . \qquad ( 1 )$$

If the prediction is correct, the estimation signal ES is equal to a value of the next time co-channel interference of the digital signal DS. In other words, when a new digital signal DS is received, a (DS−ES) calculation, i.e., subtracting the estimation signal ES from the digital signal DS, can well remove the co-channel interference iₖ from the present digital signal DS. In this case, the first digital signal DS1 contains the noises nₖ and the desired symbols aₖ only. However, if the prediction is incorrect or has a little of error, the (DS−ES) calculation cannot completely remove the co-channel interference iₖ from the digital signal DS. In this case, the first digital signal DS1 still contains a co-channel interference. As such, the first digital signal DS1 can be used for updating the tap coefficients Cᵢ of the filter 420. Or (DS1−SS) can also be used for updating the tap coefficients Cᵢ of the filter 420. The equation of updating the tap coefficients Cᵢ can be:

Cᵢ=Cᵢ+(Dᵢ*conj(DS1)*u) (2)

or

Cᵢ=Cᵢ+(Dᵢ*conj(DS1−SS)*u),

in which conj represents a conjugate complex number, u is a constant controlling a updating rate. In considering the residual co-channel interference, components of the first digital signal DS1 can be represented as:

DS1=Err+aₖ+nₖ,

in which Err represents the residual co-channel interference, nₖ represents the noises. As such the equation (2) can be expanded into:

Cᵢ=Cᵢ+(Dᵢ*conj(Err)*u)+(Dᵢ*conj(aₖ)*u)+(Dᵢ*conj(nₖ)*u),

in which (Dᵢ*conj(Err)*u) is used for updating the Cᵢ value toward correction (i.e., to reduce the Err), while the (Dᵢ*conj(aₖ)*u)+(Dᵢ*conj(nₖ)*u) are noises irrelevant to the Err. Although they may make the tap coefficients Cᵢ randomly fluctuated, when controlled by a very small rate constant, the fluctuation will be very mild, and the effect applied by the fluctuation to the Cᵢ would be expected to be 0 when considering in a long term.

The interference signal COR received by the filter 420 does not contain the symbols aₖ of the digital signal DS, and therefore the output of the filter 420, i.e., the estimation signal ES, does not contain the symbols aₖ. As such, the output from the filter 420 would not cause any inter-symbol interference to the digital signal DS before the digital signal DS is inputted into the slicer 410. In other words, the signal inputted into the filter 420 does not contain any symbol, so that the filter output doesn't bring interference from previous symbols to the present symbols of the presently received digital signal DS.

Further, it should be noted that because the interference signal COR contains the noises nₖ, a part of the noises may re-enter the digital signal DS together with the estimation signal ES, which is known as a noise amplifying effect. However, because of the filter 420, the noises which re-enter the digital signal DS is only a small part of the noises nₖ, the noise amplifying effect is very small and can be almost neglected in the current embodiment.

Further, in another embodiment of the present invention, a difference between the input and the output of the slicer 410, (i.e., DS1−SS), can also be taken as the error signal by the filter 420 for adjusting the tap coefficients, which is not restricted by the present invention. To take the difference between the input and the output of the slicer 410, i.e., a result of subtracting the symbol signal SS from the first digital signal DS1, as the error signal for adjusting the tap coefficients of the filter 420, the slicer 410 should be equipped with an arithmetic unit (not shown) coupled between two terminals thereof for arithmetic calculation. The result of the arithmetic calculation is then transmitted to the filter 420 for adjusting.

In the current embodiment, the filter 420 is an adaptive filter. When the interference signal has a fixed frequency, the filter 420 can adopt a fixed tap coefficient, and is not required to dynamically adjust the tap coefficients. However, when the co-channel interference frequency is not fixed or is unknown, the filter will adjust the tap coefficient according to the error signal. Moreover, the first arithmetic unit 430 and the second arithmetic unit 440, for example, are subtractors.

### Second Embodiment

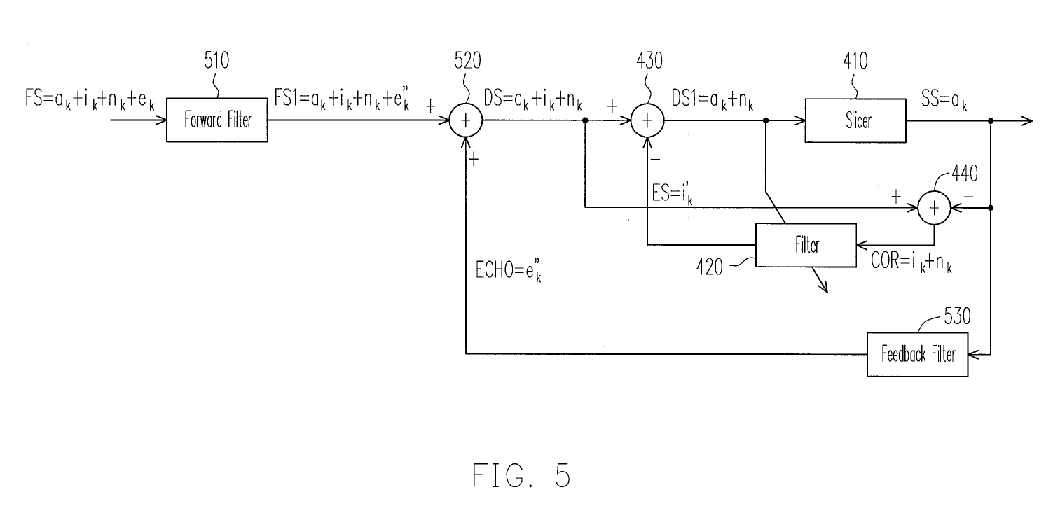

The signal processing circuit of the present invention can also be integrated into an equalizer. FIG. 5 is a circuit diagram illustrating an integration of a signal processing unit and an equalizer according to a second embodiment of the present invention. Referring to FIG. 5, FIG. 5 differs from FIG. 4 in that it further includes a forward filter 510, a third arithmetic unit 520, and a feedback filter 530. The forward filter 510 receives a forestage signal FS outputted from a forestage circuit. The forward filter 510 filters the received forestage signal FS, and outputs a first forestage signal FS1 to the third arithmetic unit 520. The feedback filter 530 receives the symbol signal SS outputted from the slicer 410. After filtering the received symbol signal SS, the feedback filter 530 then outputs an inversed echo signal ECHO to the third arithmetic unit 520. The forestage signal FS contains the echo signal, and can be represented as:

FS=aₖ+iₖ+nₖ+eₖ,

in which aₖ represents the symbols, iₖ represents the co-channel interference, nₖ represents the noises (e.g., AWGN), and eₖ represents the echo including pre-echo (e′ₖ) and post echo (e″ₖ). The forward filter 510 removes the pre-echo e′ₖ first, and the feedback filter 530 then removes the post-echo e″ₖ. As such, the first forestage signal FS1 can be represented as:

FS=aₖ+iₖ+nₖ+e″ₖ.

The third arithmetic unit 520 adds the first forestage signal FS1 with the inversed echo signal ECHO (i.e., subtracting the post echo e″ₖ therefrom), thus generating the digital signal DS (i.e., aₖ+iₖ+nₖ) received by the first arithmetic unit 430. The forward filter 510 and the feedback filer 530 are elements of the equalizer, provided mainly for removing the noises such as ghost or echo, and ISIs caused by multi-paths. In other words, the forward filter 510 and the feedback filter 530 are used for removing the noises such as ghost or echo, and ISIs from the digital signal DS, while the filter 420 is used for removing the co-channel interference from the digital signal DS.

The symbol signal SS outputted from the slicer 410 can be taken as the estimated value of the symbol data (digital data) of the received digital signal DS. The symbol signal SS is then transmitted to a trellis decoder (not shown) of a next stage for decoding. The trellis decoder is used for removing the AWGN from the symbol signal. Thereafter the digital data can be displayed.

Further, it should be noted that the signal processing circuit can be either integrated in the equalizer, or independently used in a system while the equalizer is disposed in other places of the system.

### Third Embodiment

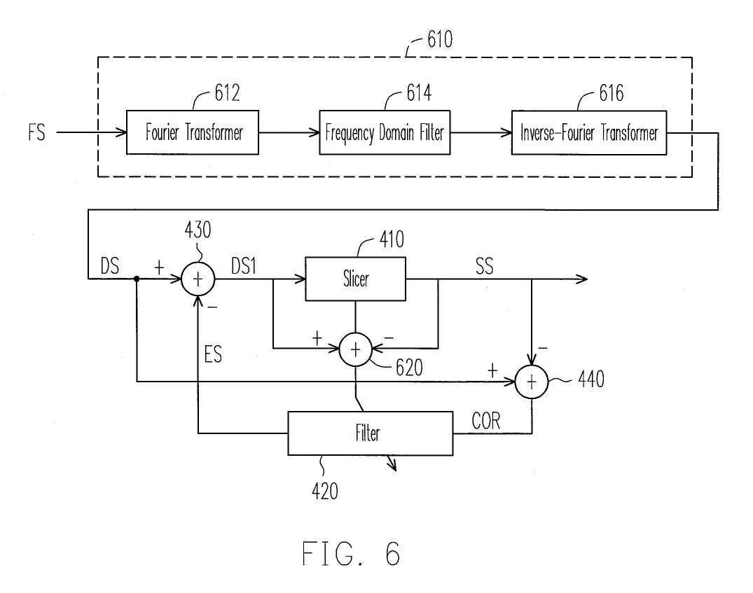

The equalizer of the second embodiment (the forward filter 510 and the feedback filter 530) can also be realized by other configurations, such as a blind equalizer. Further, when the echo is very small, the equalizer can even be turned off. As such, it is not a must of the present invention to employ such an equalizer. The equalizer can also be designed as an independent part for application. Further, a frequency domain equalizer can be used for replacing the equalizer used in the second embodiment. FIG. 6 is a circuit diagram illustrating an integration of a signal processing unit and a frequency domain equalizer according to a third embodiment of the present invention.

Referring to FIG. 6, FIG. 6 differs from FIG. 5 in that a frequency domain equalizer 610 and the filter 420 adjusts the tap coefficients according to a difference between the first digital signal DS1 and the symbol signal SS (i.e., DS1−SS). In the current embodiment, the frequency domain equalizer 610 is used instead of the forward filter 510 and the feedback filter 530 of FIG. 5, and an additional arithmetic unit 620 is employed between the input and the output of the slicer 410 for calculating the difference between the first digital signal DS1 and the symbol signal SS.

The frequency domain equalizer 610 further includes a Fourier transformer 612, a frequency domain filter 614, and an inverse-Fourier transformer 616. The frequency domain filter 614 is coupled between the Fourier transformer 612 and the inverse-Fourier transformer 616. The Fourier transformer 612 is used for performing a Fourier transformation to the forestage signal FS. In the current embodiment, the forestage signal FS may include the co-channel interference iₖ, the echoes eₖ, and baseband signals of the noises. After being Fourier transformed, the echoes eₖ are transformed into variations of amplitudes and phases of the signal of each frequency. Then, the frequency domain filter 614 regulates the amplitude and phase of each frequency. Typically, such a regulation can be accomplished by only once complex multiplication. Then the inverse-Fourier transformer 616 transforms the signal back to the time domain serving as an output of the frequency domain equalizer 610 (i.e., DS).

After the foregoing calculations of the frequency domain equalizer 610, the echoes eₖ in the baseband signal of the forestage signal FS has been removed. In other words, the frequency domain equalizer 610 can be used for replacing the forward filter 510 and the feedback filter 530 of FIG. 5.

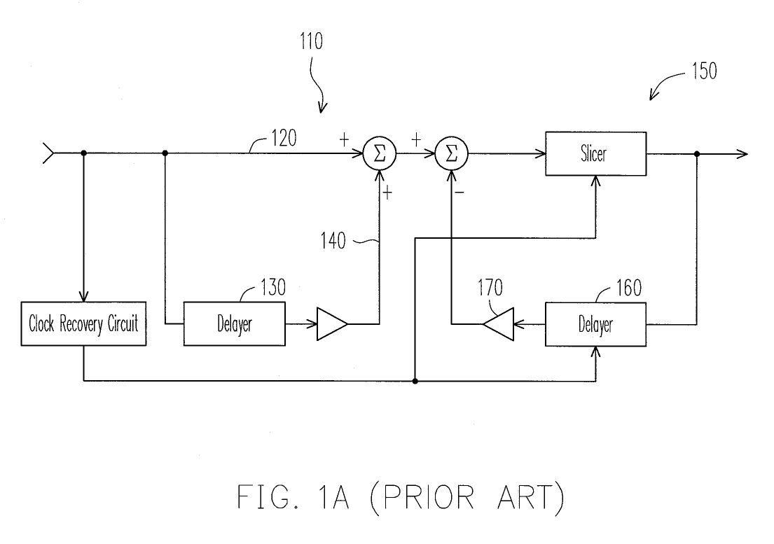

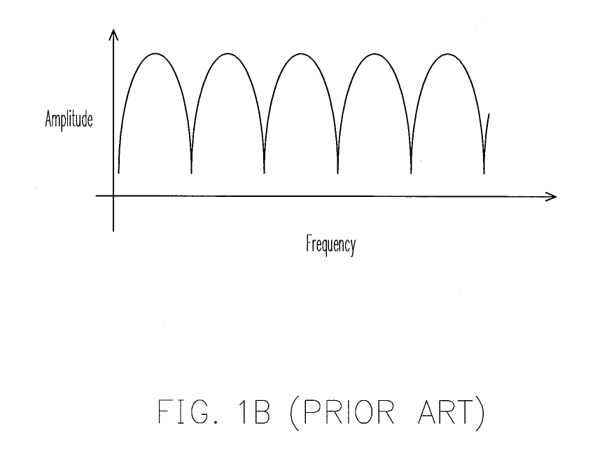

Further, it should be noted that, in the current embodiment, the tap coefficients of the filter 420 are adjusted according to a difference between the first digital signal DS1 and the symbol signal SS (i.e., DS1−SS). However, the present invention is not restricted thereby. The filter 420 can also adjust the tap coefficients-directly according to the first digital signal DS1, details of which can be learnt by referring to the first embodiment and are not to be iterated hereby. Furthermore, the embodiment of FIG. 6 is similar to the embodiment of FIG. 1 in that the input signal (the interference signal COR) of the filter 420 also does not contain the symbol signal SS, and therefore the output of the filter 420 won't cause any inter-symbol interference to the digital signal DS. Other details of the circuit and operation of FIG. 6 can be learnt by referring to the first embodiment and are not to be iterated hereby.

### Fourth Embodiment

In view of the foregoing embodiments, the present invention can be further summarized to a signal processing method, used for removing a co-channel interference from a digital signal. The digital signal includes a plurality of symbols and a co-channel interference.

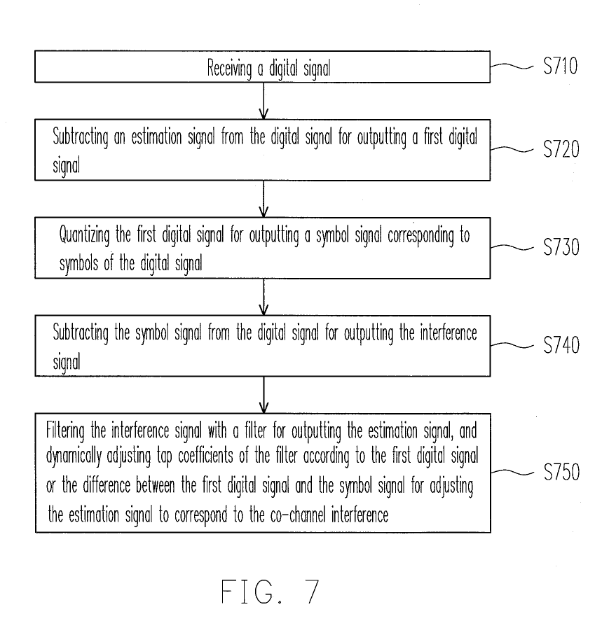

FIG. 7 is a signal processing flow chart according to a fourth embodiment of the present invention. Referring to FIG. 7, first at step S710, a digital signal is received. Then, at step S720, an estimation signal is subtracted from the digital signal, and the result of the subtraction is outputted as a first digital signal. Then at step S730, the first digital signal is quantized, and then outputted as a symbol signal corresponding to the symbols of the digital signal.

Then, at step S740, the symbol signal is subtracted from the digital signal, and then the rest of the digital signal is outputted serving as an interference signal. Then, at step S750, a filter filters the interference signal for outputting the estimation signal, and adjusts tap coefficients of the filter according to the first digital signal or the difference between the first digital signal and the symbol signal to adjust the estimation signal, so that the estimation signal corresponds to the co-channel interference in the digital signal.

Because digital signals received by the digital television are consecutive digital data, the foregoing steps S720 through S750 may be conducted with a recursive calculation, so as to continuously adjust the estimation signal according to the first digital signal DS1, and then go back to the step S720 to calculate the first digital signal DS1, for removing the co-channel interference from the digital signal DS. In the step S750, the adaptive filter takes the first digital signal DS1 as an error signal, and adjusts the tap coefficients with a specific algorithm (e.g., LMS) to predict the co-channel interference in a next calculation duty cycle, i.e., adjusting the estimation signal.

According to another embodiment of the present invention, the signal processing method further includes the following steps. A forward filter is used to filter a forestage signal so as to output a first forestage signal, and a feedback filter is used to filter the symbol signal so as to output an echo signal. Then, the echo signal outputted from the feedback filter is subtracted from the first forestage signal, and the result of the subtraction is output serving as the digital signal received in the step S710.

According to another embodiment of the present invention, the signal processing method further includes sequentially performing a equalizing calculation processes including Fourier transformation, frequency domain filtering, and inverse-Fourier transformation to the forestage signal, for outputting the digital signal.

The current embodiment subtracts the quantized symbol signal from the received digital signal, and takes the result of the subtraction as an input of the adaptive filter, and then uses the digital signal having the estimation signal subtracted therefrom, i.e., the first digital signal, as error signal for adjusting the tap coefficients of the adaptive filter. Because the input of the adaptive filter has removed the symbol data from the digital signal, the output of the adaptive filter won't cause any inter-symbol interference to the digital signal. Other operations of the signal processing method of the current embodiment can be learnt by referring to the first to the third embodiments, and are not to be iterated hereby.

In summary, the input of the adaptive filter according to the present invention is generated after subtracting the output of the slicer therefrom, and therefore the input of the adaptive filter does not contain any symbol data, so that the adaptive filter won't introduces any inter-symbol interference to the received digital signal before the slicer. In other words, the present invention is not only used for removing the co-channel interference from the digital signal, but also used for avoiding generating an inter-symbol interference.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A signal processing circuit, suitable for removing a co-channel interference from a digital signal, the digital signal comprising a plurality of symbols and a co-channel interference, the signal processing circuit comprising:
a first arithmetic unit, receiving the digital signal, and subtracting an estimation signal from the digital signal for outputting a first digital signal;
a slicer, coupled with the first arithmetic unit, for quantizing the first digital signal for outputting a symbol signal corresponding to the symbols;
a second arithmetic unit, coupled to an output of the slicer, for subtracting the symbol signal from the digital signal for outputting an interference signal; and
a filter, coupled between the first arithmetic unit and the second arithmetic unit, for filtering the interference signal and outputting the estimation signal.

2. The signal processing circuit according to claim 1, wherein the filter has a plurality of tap coefficients, and is used for dynamically adjusting the tap coefficients according to the first digital signal, for adjusting the estimation signal to correspond to the co-channel interference.

3. The signal processing circuit according to claim 1 further comprising:
a third arithmetic unit, coupled between an input and the output of the slicer, for calculating a difference between the first digital signal and the symbol signal,
wherein the filter has a plurality of tap coefficients, and is used for dynamically adjusting the tap coefficients according to the difference between the first digital signal and the symbol signal, for adjusting the estimation signal to correspond to the co-channel interference.

4. The signal processing circuit according to claim 1, wherein the filter is an adaptive filter.

5. The signal processing circuit according to claim 1, wherein both of the first arithmetic unit and the second arithmetic unit are subtractors.

6. The signal processing circuit according to claim 1 further comprising:
a forward filter, for filtering a forestage signal, so as to output a first forestage signal; and
a feedback filter, coupled to the output of the slicer, for filtering the symbol signal, so as to output an echo signal to a third arithmetic unit,
wherein the third arithmetic unit is coupled between the forward filter and the feedback filter, for subtracting the echo signal from the first forestage signal, and outputting the digital signal.

7. The signal processing circuit according to claim 6, wherein third arithmetic unit is a subtractor.

8. The signal processing circuit according to claim 6, wherein when the feedback filter outputs an inversed signal of the echo signal, the third arithmetic unit adds the first forestage signal with the inversed signal of the echo signal for outputting the digital signal.

9. The signal processing circuit according to claim 6 further comprising:
a fourth arithmetic unit, coupled between an input and the output of the slicer, for calculating a difference between the first digital signal and the symbol signal,
wherein the filter has a plurality of tap coefficients, and is used for dynamically adjusting the tap coefficients according to the difference between the first digital signal and the symbol signal, so as to adjust the estimation signal to correspond to the co-channel interference.

10. The signal processing circuit according to claim 1 further comprising:
a frequency domain equalizer, for equalizing a forestage signal thus outputting the digital signal.

11. The signal processing circuit according to claim 10 further comprising:
a Fourier transformer, for performing a Fourier transformation to the forestage signal;
a frequency domain filter, coupled to an output of the Fourier transformer; and
an inverse-Fourier transformer, coupled to an output of the frequency domain filter, and is used for transforming the output of the frequency domain filter to generate the digital signal in time domain.

12. The signal processing circuit according to claim 10 further comprising:
a third arithmetic unit, coupled between an input and the output of the slicer, for calculating a difference between the first digital signal and the symbol signal,
wherein the filter has a plurality of tap coefficients, and is used for dynamically adjusting the tap coefficients according to the difference between the first digital signal and the symbol signal, for adjusting the estimation signal to correspond to the co-channel interference.

13. The signal processing circuit according to claim 1, wherein the first digital signal is an error signal for the filter.

14. The signal processing circuit according to claim 1, wherein an algorithm employed by the filter for adjusting the tap coefficients comprises a least mean square (LMS) algorithm.

15. A signal processing method, comprising:
receiving a digital signal, the digital signal including a plurality of symbols and a co-channel interference;
subtracting an estimation signal from the digital signal for outputting a first digital signal;
quantizing the first digital signal for outputting a symbol signal corresponding to the symbols;
subtracting the symbol signal from the digital signal for outputting an interference signal; and
filtering the interference signal with a filter for outputting the estimation signal.

16. The signal processing method according to claim 15, wherein the step of filtering the interference signal with a filter for outputting the estimation signal further comprises:
dynamically adjusting a plurality of tap coefficients of the filter according to the first digital signal for adjusting the estimation signal to correspond to the co-channel interference.

17. The signal processing method according to claim 15, wherein an algorithm employed by the filter for adjusting the tap coefficients comprises a least mean square (LMS) algorithm.

18. The signal processing method according to claim 15, wherein the step of filtering the interference signal with a filter for outputting the estimation signal further comprises:
dynamically adjusting a plurality of tap coefficients of the filter according to the difference between the first digital signal and the symbol signal for adjusting the estimation signal to correspond to the co-channel interference.

19. The signal processing method according to claim 15 further comprising:
using a forward filter to filter a forestage signal for outputting a first forestage signal;
using a feedback filter to filter the symbol signal for outputting an echo signal; and
subtracting the echo signal from the first forestage signal for outputting the digital signal.

20. The signal processing method according to claim 15 further comprising:
equalizing a forestage signal for outputting the digital signal.

21. The signal processing method according to claim 20, wherein the step of equalizing a forestage signal for outputting the digital signal further comprises:
sequentially performing a Fourier transformation, a frequency domain filtering, and an inverse-Fourier transformation to the forestage signal, for outputting the digital signal.

22. The signal processing method according to claim 15, wherein the filter is an adaptive filter.
